(19) United States
(12) Patent Application Publication
(10) Pub. No.: US 2017/0251254 A1
(43) Pub. Date: Aug. 31, 2017

(54) TRACING PIRACY OF LIVE BROADCASTS

(71) Applicant: Verance Corporation, San Diego, CA (US)

(72) Inventors: Jeffrey Bruce Lotspiech, San Diego, CA (US); Joseph M. Winograd, San Diego, CA (US)

(21) Appl. No.: 15/506,688

(22) PCT Filed: Aug. 27, 2014
(86) PCT No.: PCT/US2014/052973

§ 371 Date: Feb. 24, 2017

(51) Int. Cl. H04N 21/442; H04L 29/06; H04N 21/858; H04N 21/4627; H04N 21/8358; H04L 9/14; H04N 21/266

(52) U.S. Cl. CPC H04N 21/44236; H04L 9/14; H04L 63/0428; H04N 21/26613; H04N 21/4627; H04N 21/8358; H04N 21/8586

(57) ABSTRACT

Methods, devices, systems and computer program products enable generation, distribution and management of live broadcast content in such a way so as to allow identification of a pirate device or subscriber quickly and efficiently. Content is divided into content blocks, where each content block is divided into content units. Each of the content units is selectable from n variations of the content unit and a majority of ail possible combinations of content unit variations are permissible to be selected for production of the uniquely identifiable content. The content blocks, including the n variations of the content units, a media block key, and at least one device key is delivered to an authorized device. A particular pattern of content units is generated that identifies which of the n content unit variations must be used by the authorized device for constructing each content block.

### FIELD OF INVENTION

The present application generally relates to the field of content management. More particularly, the disclosed embodiments relate to detection of unauthorized content distribution.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Real-time piracy of broadcast content occurs when a recipient of the content retransmits it to other recipients without permission from the owner or rights-holder to the content while the broadcast is occurring. Real-time content piracy is of particular concern for sporting events, competitions, elections, speeches, and breaking news that can significantly diminish in commercial value once the content or the outcome of the event becomes publicly known.

Such broadcast streams can contain audio or audiovisual content. The term “broadcast” can be used in the context of audio or audiovisual content that is distributed simultaneously (or nearly simultaneously) to viewers at remote locations. However, the term “broadcast” does not constrain or limit the underlying distribution technologies employed, which may be “broadcast” in the technical sense of a single transmission of the content delivered to multiple locations but may also be “multicast” in the technical sense of multiple separate transmissions (which may or may not be identical) of the content to each of the multiple locations.

### SUMMARY

The disclosed embodiments relate to methods, systems, devices and computer program products for generation, distribution and management of live broadcast content in such a way so as to allow identification of a pirate device or subscriber quickly and efficiently. The disclosed embodiments further enable rapid identification of a culprit device and/or culprit subscriber that is participating in content piracy.

One aspect of the disclosed embodiments relates to a method for thwarting real-time piracy of a content that includes (a) obtaining a first portion of a content from a distribution network while the content is being provided to one or more authorized subscribers or one or more authorized devices, where the first portion includes a first content block. The content that is being provided to the one or more authorized subscribers or the one or more authorized devices includes a plurality of content blocks, where each content block comprising m content units, and each content unit having been selected from one of n variations of the content unit. Each of m and n is greater than or equal to 2 and a majority of all possible combinations of content units are permissible to be selected for production of a uniquely identifiable content. The one or more authorized subscribers or the one or more authorized devices further having been provided a plurality of media key blocks, where each media key block is associated with a corresponding content block. The one or more authorized subscribers or the one or more authorized devices also having been provided with at least one device key for computing a media key from the media key block used for obtaining a particular pattern of content unit variants for the corresponding content block. The above noted method also includes (b) discerning from the first portion of the content a particular pattern of content unit variation present in the first content block to thereby narrow an identity of a culprit device or subscriber to within 1/n^{m} of all possible subscribers or devices. The method further includes (c) obtaining a second portion of the content from the distribution network while the content is being provided to the one or more authorized subscribers or one or more authorized devices, where the second portion includes a second content block. The above described method additionally includes (d) discerning from the second portion of the content a particular pattern of content unit variation present in the second content block to thereby narrow the identity of the culprit device or culprit subscriber by an additional factor of 1/n^{m} of all possible device or subscribers, and (e) making a determination as to whether or not a single culprit device or subscriber has been identified. The method further includes (f) upon a determination that a single culprit device or culprit subscriber has been identified, providing an indication that the single culprit device or culprit subscriber has been identified, and upon a determination that a single culprit device or culprit subscriber has not been identified, obtaining an additional portion of the content including an additional content block, and repeating operations (d), (e) and (f) using the additional portion of the content and the additional content block in place of the second portion of the content and the second content block, respectively.

In one exemplary embodiment, m and n are selected such that the culprit device or culprit subscriber is identified upon a single execution of operations (a) through (e). In another exemplary embodiment, n is equal to 2. In yet another exemplary embodiment, each variation of the content unit is produced by embedding one of n watermark values into each content unit. In still another exemplary embodiment, each variation of the content unit is produced by encrypting each content unit using n distinct encryption keys, while in another exemplary embodiment, each variation of the content unit is produced by allowing each content unit to be obtained using a uniform resource locator (URL) that includes a difficult-to-guess portion. In one particular exemplary embodiment, the difficult-to-guess portion of the URL includes a value of a block unit key. In another exemplary embodiment, the difficult-to-guess portion of the URL includes a hash value of a block unit key.

According to one exemplary embodiment, all possible combinations of content units are permissible to be selected for production of the uniquely identifiable content. In another exemplary embodiment, the at least one device key is delivered to the authorized device as a key with length d1 and upon reception at the authorized device, the length d1 is extended to a length d2 to compute the media key.

Another aspect of the disclosed embodiments relates to a device that includes a processor, and a memory that includes processor executable code. The processor executable code when executed by the processor causes the device to: (a) obtain a first portion of a content from a distribution network while the content is being provided to one or more authorized subscribers or one or more authorized devices, the first portion including a first content block. The content being provided to the one or more authorized subscribers or the one or more authorized devices comprises a plurality of content blocks, where each content block includes m content units. Each content unit having been selected from one of n variations of the content unit, where each of m and n is greater than or equal to 2 and a majority of all possible combinations of content units are permissible to be selected for production of a uniquely identifiable content. The one or more authorized subscribers or the one or more authorized devices having been provided a plurality of media key blocks, where each media key block is associated with a corresponding content block. The one or more authorized subscribers or the one or more authorized devices further having been provided with at least one device key for computing a media key from the media key block used for obtaining a particular pattern of content unit variants for the corresponding content block. The processor executable code when executed by the processor causes the device to (b) discern from the first portion of the content a particular pattern of content unit variation present in the first content block to thereby narrow an identity of a culprit device or subscriber to within 1/n^{m} of all possible subscribers or devices, and (c) to obtain a second portion of the content from the distribution network while the content is being provided to the one or more authorized subscribers or one or more authorized devices, where the second portion includes a second content block. The processor executable code when executed by the processor causes the device to (d) discern from the second portion of the content a particular pattern of content unit variation present in the second content block to thereby narrow the identity of the culprit device or subscriber by an additional factor of 1/n^{m} of all possible device or subscribers, and (e) to make a determination as to whether or not a single culprit device or subscriber has been identified. The processor executable code when executed by the processor causes the device to (f) upon a determination that a single culprit device or culprit subscriber has been identified, provide an indication that the single culprit device or culprit subscriber has been identified, and upon a determination that a single culprit device or culprit subscriber has not been identified, obtain an additional portion of the content including an additional content block, and repeat operations (d), (e) and (f) using the additional portion of the content and the additional content block in place of the second portion of the content and the second content block, respectively.

Another aspect of the disclosed embodiments relates to a computer program product embodiment on one or more non-transitory computer readable media. The computer program product includes computer code for (a) obtaining a first portion of a content from a distribution network while the content is being provided to one or more authorized subscribers or one or more authorized devices, the first portion including a first content block. The content being provided to the one or more authorized subscribers or the one or more authorized devices comprises a plurality of content blocks, where each content block includes m content units, each content unit having been selected from one of n variations of the content unit, wherein each of m and n is greater than or equal to 2 and a majority of all possible combinations of content units are permissible to be selected for production of a uniquely identifiable content. The one or more authorized subscribers or the one or more authorized devices having been provided a plurality of media key blocks, where each media key block is associated with a corresponding content block. The one or more authorized subscribers or the one or more authorized devices further having been provided with at least one device key for computing a media key from the media key block used for obtaining a particular pattern of content unit variants for the corresponding content block. The computer program produce further includes computer code for (b) discerning from the first portion of the content a particular pattern of content unit variation present in the first content block to thereby narrow an identity of a culprit device or subscriber to within 1/n^{m} of all possible subscribers or devices, and computer code for (c) obtaining a second portion of the content from the distribution network while the content is being provided to the one or more authorized subscribers or one or more authorized devices, where the second portion includes a second content block. The computer program product also includes computer code for (d) discerning from the second portion of the content a particular pattern of content unit variation present in the second content block to thereby narrow the identity of the culprit device or subscriber by an additional factor of 1/n^{m} of all possible device or subscriber, and computer code for (e) making a determination as to whether or not a single culprit device or subscriber has been identified. The computer program product also includes computer code for (f) upon a determination that a single culprit device or culprit subscriber has been identified, providing an indication that the single culprit device or culprit subscriber has been identified, and upon a determination that a single culprit device or culprit subscriber has not been identified, obtaining an additional portion of the content including an additional content block, and repeating operations (d), (e) and (f) using the additional portion of the content and the additional content block in place of the second portion of the content and the second content block, respectively.

Another aspect of the disclosed embodiments relates to a method for producing a uniquely identifiable content for real-time distribution, where the method includes dividing the content into a plurality of content blocks, and dividing each content block into m content units. Each of the m content units is selectable from n variations of the content unit, each of m and n is greater than or equal to 2 and a majority of all possible combinations of content unit variations are permissible to be selected for production of the uniquely identifiable content. The method also includes providing the plurality of content blocks, a media block key associated with each of the plurality of content blocks, and at least one device key to an authorized subscriber or an authorized device, where each content block includes the n variations of the content units. The method additionally includes producing a particular pattern of content units that identifies which of the n content unit variations must be used by the authorized device for constructing each content block, where the particular pattern can be ascertained by the authorized device using the device key and the media block key.

In one exemplary embodiment, m and n are selected such that the culprit device or culprit subscriber is identifiable from two content blocks. In another exemplary embodiment, the method includes producing each variation of the content unit by embedding one of n watermark values into each content unit. In yet another exemplary embodiment, the method includes producing each variation of the content unit by encrypting each content unit using n distinct encryption keys. In still another exemplary embodiment, the method includes producing each variation of the content unit using a uniform resource locator (URL) that includes a difficult-to-guess portion. For example, the difficult-to-guess portion of the URL can includes a value of a block unit key. In another example embodiment, the difficult-to-guess portion of the URL includes a hash value of a block unit key.

According to one exemplary embodiment, all possible combinations of content units are permissible to be selected for production of the uniquely identifiable content. In another exemplary embodiment, the method includes delivering the at least one device key to the authorized device as a key with length d1 that is shorter than a length d2 needed to compute the media key. In another exemplary embodiment, the plurality of content blocks are delivered to the authorized device as a real-time content, and the at least one device key is delivered to the authorized device or the authorized user prior to real-time delivery of the content blocks.

Another aspect of the disclosed embodiments relates to a device that includes a processor and a memory including processor executable code. The processor executable code, when executed by the processor, causes the device to divide the content into a plurality of content blocks, and divide each content block into m content units. Each of the m content units is selectable from n variations of the content unit, each of m and n is greater than or equal to 2 and a majority of all possible combinations of content unit variations are permissible to be selected for production of the uniquely identifiable content. The processor executable code, when executed by the processor, also causes the device to provide the plurality of content blocks, a media block key associated with each of the plurality of content blocks, and at least one device key for transmission to an authorized subscriber or an authorized device, where each content block includes the n variations of the content units. The processor executable code, when executed by the processor, further causes the device to produce a particular pattern of content units that identifies which of the n content unit variations must be used by the authorized device for constructing each content block, where the particular pattern can be ascertained by the authorized device using the device key and the media block key.

In one exemplary embodiment, in and n are selected such that the culprit device or culprit subscriber is identifiable from two content blocks. In another exemplary embodiment, the processor executable code, when executed by the processor, causes the device to produce each variation of the content unit by embedding one of n watermark values into each content unit. In yet another exemplary embodiment, the processor executable code, when executed by the processor, causes the device to produce each variation of the content unit by encrypting each content unit using n distinct encryption keys. In still another exemplary embodiment, the processor executable code, when executed by the processor, causes the device to produce each variation of the content unit using a uniform resource locator (URL) that includes a difficult-to-guess portion.

According to another exemplary embodiment, the processor executable code, when executed by the processor, causes the device to deliver the at least one device key to the authorized device as a key with length d1 that is shorter than a length d2 needed to compute the media key. In another exemplary embodiment, the processor executable code, when executed by the processor, causes the device to deliver the plurality of content blocks to the authorized device as a real-time content, and the at least one device key to the authorized device or the authorized user prior to real-time delivery of the content blocks.

Another aspect of the disclosed embodiments relates to a computer program product embodiment on one or more non-transitory computer readable media. The computer program product includes computer code for dividing the content into a plurality of content blocks, and dividing each content block into m content units. Each of the m content units is selectable from n variations of the content unit, each of m and n is greater than or equal to 2 and a majority of all possible combinations of content unit variations are permissible to be selected for production of the uniquely identifiable content. The computer program product also includes computer code for providing the plurality of content blocks, a media block key associated with each of the plurality of content blocks, and at least one device key to an authorized subscriber or an authorized device, where each content block includes the n variations of the content units. The computer program product also includes computer code for producing a particular pattern of content units that identifies which of the n content unit variations must be used by the authorized device for constructing each content block, where the particular pattern can be ascertained by the authorized device using the device key and the media block key

It should be noted that any of the disclosed embodiments can be combined with other disclosed embodiments of the present application.

### BRIEF DESCRIPTION OF THE DRAWINGS

FIG. 1 illustrates content segmentation that can be used for delivery of a live broadcast content in accordance with an exemplary embodiment.

FIG. 2 illustrates particular content unit variations selected by an authorized device in accordance with an exemplary embodiment.

FIG. 3 illustrates a set of operations 300 that can be carried out to produce a uniquely identifiable content for real-time distribution in accordance with an exemplary embodiment.

FIG. 4 illustrates a set of operations 400 that can be carried out to thwarting real-time piracy of a content in accordance with an exemplary embodiment.

FIG. 5 illustrates a block diagram of a device 500 within which various disclosed embodiments may be implemented.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

In 1994 Benny Chor, Amos Fiat, Moni Naor, and Benny Pinkas published a paper entitled “Tracing Traitors” in the Proceedings of the 14th Annual International Cryptology Conference, on Advances in Cryptology. This idea has become a large and active area of research in cryptography. The original name “tracing traitors” continues to be used.

The disclosed embodiments relate to systems, devices, methods and computer program products that thwart piracy of broadcast content.

The basic concept of tracing traitors is to divide content into multiple segments, and for each segment, provide perceptually equivalent but differently encrypted variations. Each user is given the keys for only one variation for a given segment. If the content is recovered in a pirate copy, by looking at the variations in it, it may be possible to determine the user or users who created the pirate copy.

There are many ways in which a variation may be detected in a pirate copy. It might be detected by the cryptographic key that the pirate has circulated, or by the URL of the variation, or by a visible mark in the variation, or by a perceptually invisible mark in the variation. The latter is called a digital watermark, and is particularly useful in certain disclosed embodiments of this application. However, all methods of detecting variations are within the scope of the disclosed embodiments.

The Advanced Access Content System uses one tracing technology to protect Blu-ray optical discs. The Blu-ray system, as is typical of theoretical papers in the cryptographic literature, spends almost all of the extra space on the disc to solve the problem of collusion. In this context, collusion means that a group of attackers have merged their variations together to produce the pirate copy. In the context of live broadcasts, collusion is much less important (for reasons explained below) and the Blu-ray solution would be both ineffective and unduly expensive in bandwidth.

One application of a tracing traitors system is in a live, pay-per-view video broadcast, where a significant source of lost revenue occurs when a subscriber, receiving the legitimate broadcast, turns around and rebroadcasts it for free or for a reduced price. Such pirated content can, for example, be available on the Internet. If the variations in the rebroadcast content uniquely identifies the subscriber, he/she can be cut off from the stream before the end of the broadcast.

If a group of users were to “mix and match”, that is, they were to produce their pirate broadcast by selecting individual segments from each of them, it greatly complicates their attack. Unavoidably, each of the users will be slightly out of synchronization with each other, and the effort necessary to make the rebroadcast appear seamless to their clients is non-trivial. It certainly is not a function that is available in off-the-shelf server software. Far simpler for them to rebroadcast from a single user, and if and when that user is stopped, switch to another. That switch might also not be seamless to their clients, but it happens much less frequently. This latter attack has been called in the art the “scapegoat attack”. Therefore, in a real-time piracy application, the scapegoat attack is much more likely than a mix-and-match attack.

In many applications, the detection of a colluded content that has been produced by a mix-and-match technique can be done quickly. For example, in Blu-ray systems, the content block (basically an entire movie) has a large number (i.e., 2^{M}) of possible patterns of variations, of which only a 256 are used in a given movie. Attackers who are mixing-and-matching the content units have a negligible chance (i.e., 2⁻⁵⁶) of picking a valid pattern. Therefore, mix-and-match attackers will almost always generate an invalid pattern and the tracing agency will know immediately that the attack is a collusion. This comes at a cost, however. In Blu-ray, it takes 6 full movies to identify a single attacker. In a real-time piracy application, it is far better to detect a single pirate quickly than to be able to detect that a collusion exists quickly since identification of a single pirate (in a scapegoat attack) allows the system to respond immediately to stop or thwart content piracy by, for example, revoking the attacker's credentials. To this end, the disclosed embodiments facilitate the detection of a scapegoat attack and provide for quick identification of the culprit device or attacker.

In some exemplary embodiments, two variations of each content segment is produced prior to broadcast, although any number of variations are within the scope of the present invention. When the content is provided to a subscriber, the pattern of switching between the two variations uniquely identifies each subscriber, or the subscriber's device. The production of the unique content by switching between the different variations can occur at the broadcaster, at a distribution node between the broadcaster and the subscriber, or at that subscriber (e.g., at a secure set-top box). However, in the exemplary embodiments that are described below, it is assumed that both (or all) content variations are available to the subscriber and switching occurs at the subscriber premises.

As noted above, in some applications, the variations in content segments can be produced by embedding different watermarks into content segments (see e.g., U.S. Pat. Nos. 6,612,315 and 7,644,282, herein incorporated by reference—the '282 patent utilize a smaller transmission bandwidth but still enable embedding of forensic watermarks into the content that is based on two pre-processed versions of the content).

In the description that follows, references and examples have been provided that reference Blu-ray pre-recorded video content encryption, decryption and key management. These examples are provided to facilitate the understanding of the disclosed embodiments. It is understood, however, that the disclosed techniques are applicable to a wide range of cryptographic systems and content distribution paradigms and techniques. Examples of such content distribution techniques include HTTP Live Streaming (also known as HLS), Dynamic Adaptive Streaming over HTTP (DASH) (also known as MPEG-DASH) or other techniques that use secure socket layer (SSL) or other methods for enabling live content broadcast from a server to a client.

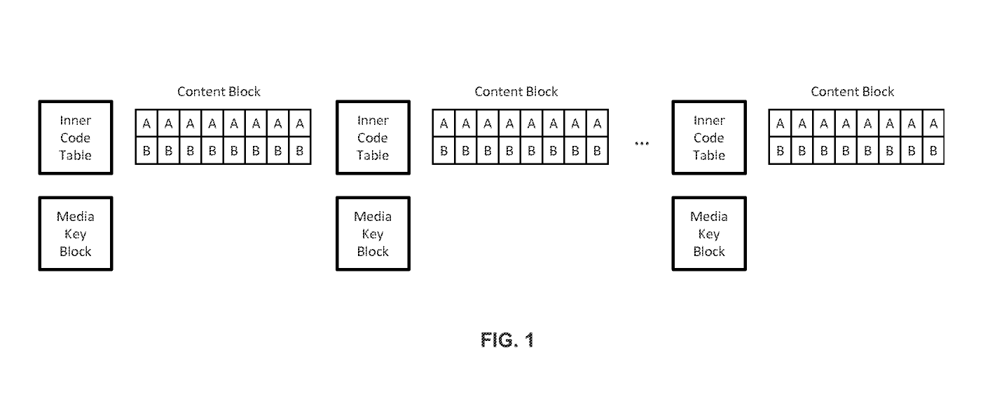

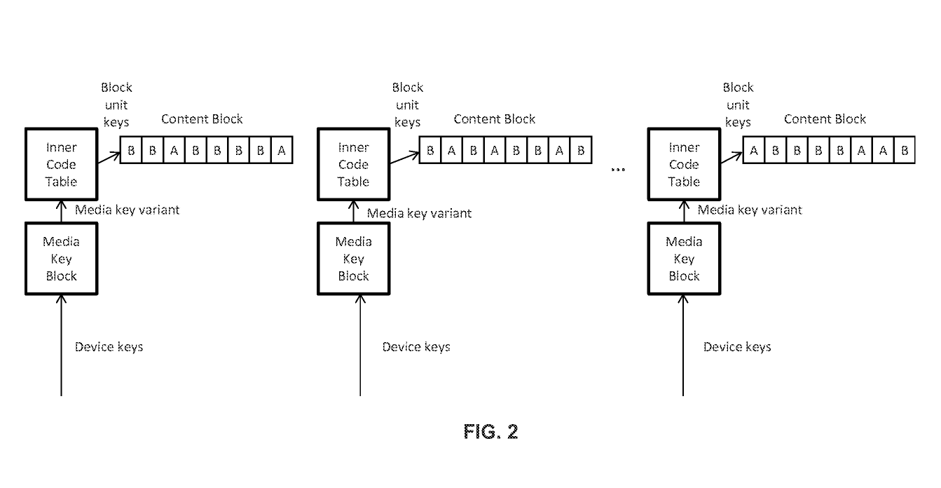

An exemplary scenario of a live broadcast can be illustrated with the aid of FIGS. 1 and 2. In the illustration in FIG. 1, a live broadcast is provides in two streams, a first stream with the A variation and a second stream with the B variation. Furthermore, the streams are divided into “content units” of a few seconds duration, as illustrated in FIG. 1 by small boxes around each of the letter A and B. Eight consecutive content units can be combined into a “content block.” The numbers and parameters shown in FIGS. 1 and 2 are arbitrarily provided for the sake of illustration and other numbers or parameters can be used. In general, a content can be divided into a plurality of content blocks, each comprising ‘m’ content units, where each content unit is selected from one of possible ‘n’ variations of that content unit. Each of m and n is selected to be greater than or equal to 2. The upper bounds on the values of m and n can be selected to accommodate the desired levels of security and computational complexity. Further, these values can be changed for each content block. In some exemplary embodiments, these values selected from the following ranges: 2≦m≦10 and 2≦n≦4. As illustrated in each of FIGS. 1 and 2, at the beginning of each content block a “media key block” (this is called a “sequence key block” in Blu-ray systems) and an “inner code table” are broadcast. The media key block allows each subscriber's player to calculate one of 256 media key variants. The player then uses the calculated media key variant to decrypt a row in the inner code table which tells the player the particular pattern of A and B content units that should be played, as well as the cryptographic key for each content unit (i.e., the “content unit key”).

FIG. 2 shows, for example, the selection of the sequence BBABBBBA content units for the first content block, the selection of the sequence BABABBAB content units for the second content block, and the selection of the sequence ABBBBAAB content units for the third content block at the player. To process the media key block, the player is provided with a set of device keys (these are called “sequence keys” in a Blu-ray system) when the subscriber purchases the live event. The media key block is also used to revoke guilty subscribers; in particular, once the guilty subscribe has been identified, the media key blocks that are broadcast from that point on do not allow his/her device keys to calculate a media key variant. Blu-ray's Advanced Access Content System Pre-recorded Video Book, available on the Web, provides further details as to how media (sequence) key blocks operate.

As noted earlier, in Blu-ray systems, the restriction of content patterns to 256, facilitates quick identification of that fact of a collusion (not, however, who the colluders are). In real-time piracy detection, it is more beneficial to quickly identify a single attacker rather than detecting that a collusion exists, because single attackers are much more likely due to the reasons stated above. To facilitate quick identification of an attacker, a system is designed that allows more useable patterns (i.e., more than 256 and up to all possible patterns). In such a system, a mix-and-match attacker always produces a valid pattern, and furthermore, some legitimate players can produce the same pattern as the one produced by collusion. Therefore, it becomes critically important that the tracing agency does not incriminate innocent subscribers in the unlikely event there is a collusion.

In one exemplary embodiment, assuming again that 8 content units per content block are used, after the rebroadcast content block from a first pirate identity is recovered, the agency starts a list of suspects that are 1/256 of all the subscribers. If it is a mix-and-match attack, it will turn out that they are all innocent. After the second rebroadcast content block is recovered, the suspect group is winnowed down by another 1/256 of the population to 1/65.536 of all subscribers. After the third rebroadcast content block is recovered, the suspect group is down to 1/16,772,216 (approximated as 1/16 Million) of the whole population, which is likely a single subscriber. But now it is the mix-and-match attackers who have a real problem. They have no way of knowing how the innocent subscriber they have fingered will produce the fourth content block, as the device keys are randomly assigned. Thus if the pirates guess wrong, the tracing agency will know that it is a collusion, and the agency can use one of the standard collusion detection techniques to identify the guilty parties. In this exemplary scenario, the pirates only have a 1/256 chance of guessing the correct sequence of content units that the innocent party would produce. Conversely, if a single subscriber of a population of 16 million could have produced the four content blocks seen in the rebroadcast, the probability that he is the single attacker is 255/256. Recovery of subsequent blocks increases the probability of guilt (by a factor of 256). If the probability that the guilty party is correctly identified reaches a particular threshold, the tracing agency can take actions to thwart the real time content piracy, such as to revoke the guilty subscriber.

There is a slight simplification in the above description: it turns out, because of possible watermark detection ambiguity and/or revocation of previous attackers, it is possible that multiple device keys might produce a single media key variant. In that case, the probabilities are not 1/256, they are k/256, where ‘k’ is the number of device keys that would have calculated that single media key variant. The remaining operations remain the same until the desired probability of pirate identification is achieved.

Referring back to FIGS. 1 and 2, each content unit is associated with a cryptographic key called a “content unit key;” each variation of a content unit has a separate key. In the above example of FIG. 1, a separate content unit key can be provided for each of the A and B versions of the content units. In such a scheme, a content block that is constructed using 16 content units (8 A units plus 8 B units) has 16 content unit keys, although a given player would only be able to calculate 8 content unit keys per content block.

It should be noted that, for simplicity, all content blocks in the above examples have been illustrated as having an equal number of m content units. However, it is understood that content blocks with varying number of content units can be used. In particular, a content can be divided into content blocks with {m₁, m₂, m₃, . . . mᵢ} content units (i.e., first content block can be constructed using any one of n^{m1} content unit variations, second content block can be constructed using any one of n^{m2} content unit variations and so on). In this scenario, the discovery of the first content block narrows down the culprit device to 1/n^{m1} possibilities, the discovery of second content block narrows the culprit device to (1/n^{m1})(1/n^{m2}) possibilities and so on.

In the example scheme of FIGS. 1 and 2, a content unit key must be used to decrypt a particular content unit variation. However, incorporating a decryption component into an existing player (e.g., in a device that requests and receives a live broadcast content for viewing) may not be practical. The need for the decryption operation may be eliminated by providing a URL (Universal Resource Locator, its address on the Web) of the content unit variation that is not easily guessable. In this case, each content unit has its own URL. When this technique is utilized, an attacker can only rebroadcast the URLs that he/she knows; when such content is rebroadcast, the content unit variations identify the culprit player.

To further improve the above technique, the URLs can be constructed in such a way that their discovery is not feasible for a real time content pirate. In some embodiments, such unguessable (or difficult-to-guess) URLs are produced by including the value of the block unit key (e.g., in hexadecimal format) as part of the URL. In particular, the difficult-to-guess URLs can be designed such that it would not be economically feasible for an attacker (or attackers) to determine the URL values within the duration of the live broadcast content (e.g., 2 hours). Alternatively, a one-way function (such as a cryptographic hash) of the block unit key can be included as part of the URL. The latter technique provides an unguessable URL and further effectuates the encryption of the content unit variation itself so that the URL doesn't reveal the key. In systems that utilize such unguessable URLs, the pirate is unable (or unlikely) to guess and obtain additional content blocks associated with other players.

One feature of the disclosed techniques is that there are no long-lived keys in the system. A different set of device keys are established for each live event, generated from a random source. Likewise, the many media key variants and block unit keys used during the broadcast are randomly generated and are statistically unique for each event. These keys rapidly lose their value since, within a couple of hours after the end of the live event, the keys would be basically useless to an attacker—it would be too late to get any value by rebroadcasting.

Another feature of the disclosed techniques is that cryptanalysis of the key space (e.g., an exhaustive search for keys by testing all possible values) is not a viable attack. Currently, a cryptographic key length of 128 bits is considered to be secure enough for many standard applications. In the disclosed real-time content broadcast systems, however, shorter keys lengths (e.g., 64-bit or even 48-bit keys) provide sufficient security since it is unlikely that such shorter keys can be uncovered by attackers in less than a few hours time. According to the disclosed embodiments, a key with length d1 that is shorter than a length d2 needed to compute the media key can be delivered to an authorized device or an authorized subscriber. As described in more detail below, such a shorter key can be expanded to an appropriate length for use by the authorized device. Obviously, any key can be broken through utilization of additional computational resources. To this end, the key length can be adjusted as necessary to make the use of such additional resources economically infeasible.

Further, the device keys, which typically begin being delivered to subscribers a couple of weeks before the start of the live event, can be reduced in length since these keys are not used until the live event begins. Thus even though device keys are out in the world, there is no data (i.e., the media key blocks that are inserted into the live broadcast) to start the exhaustive search of the key space to find those keys until the broadcast of the live event commences. The amount of bandwidth required to deliver all the keys to all the subscribers for an event, if it were averaged over the couple of weeks prior to the event, is negligible. Unfortunately, many subscribers wait until the last moment to purchase the event, and thus there is a bandwidth peak at that time. Revenue is lost if a potential customer cannot get through before the event starts. By halving the size of the device keys, for example, the bandwidth required is likewise halved, or alternatively, for a given bandwidth, the number of customers getting through is doubled.

The disclosed techniques can be further modified for use in a system that uses a block cipher such as the Advanced Encryption Standard (AES). Block ciphers, such as AES, operate on a fixed block size (e.g., 128 bits) and require a fixed encryption key (e.g., a 128-bit key). The disclosed techniques can be modified to become compatible with any block cipher that operates on a fixed block size and requires a fixed encryption key. In one example, a short key (e.g., a 64-bit key) that is used in a real-time content broadcast system can be extended to a longer key (e.g., a 128-bit key) by concatenating constant bits. The constant bits can be different from event-to-event. Further, the expanded key may be used to decrypt another event-specific constant, and that result then be used as the actual key. In that way, there are no bits that are guaranteed to be the same for any two 128-bit keys, even though the cryptographic strength of the keys is still only 64 bits.

In the media key block, a device key is used to decrypt a media key variant with a single decryption. To accommodate the use of blocks less than the standard block size (e.g., 128 bits in AES), at the beginning of the media key block a 128-bit value, called a nonce, is added. The player uses its (expanded) device key to decrypt the nonce. Then it exclusive-ors part of the result with the less-than-128-bit data for the encrypted media key variant. This part can be the high order bits or the result, the low order bits, or bits in the middle; this convention can system-wide, or it can be established event-by-event. This is, in effect, an AES decryption of less than 128-bits. This invention incorporates this nonce idea.

This approach can also be used to do decryptions of less than 128 bits starting with the device's calculated media key variant. However, in this case, there is a slight cryptographic weakness because the same value would be XORed several times, one decryption for each column in a given row in the inner code table. Because cryptanalysis is not a serious attack in this application, this weakness can be ignored. However, the fix is likewise trivial: before using the nonce at each column, the device XORs it with the column number before decrypting it with the media variant. Thus, each column gets a different result to XOR with the data in the table. Either approach (with or without the fix) is within the scope of this invention.

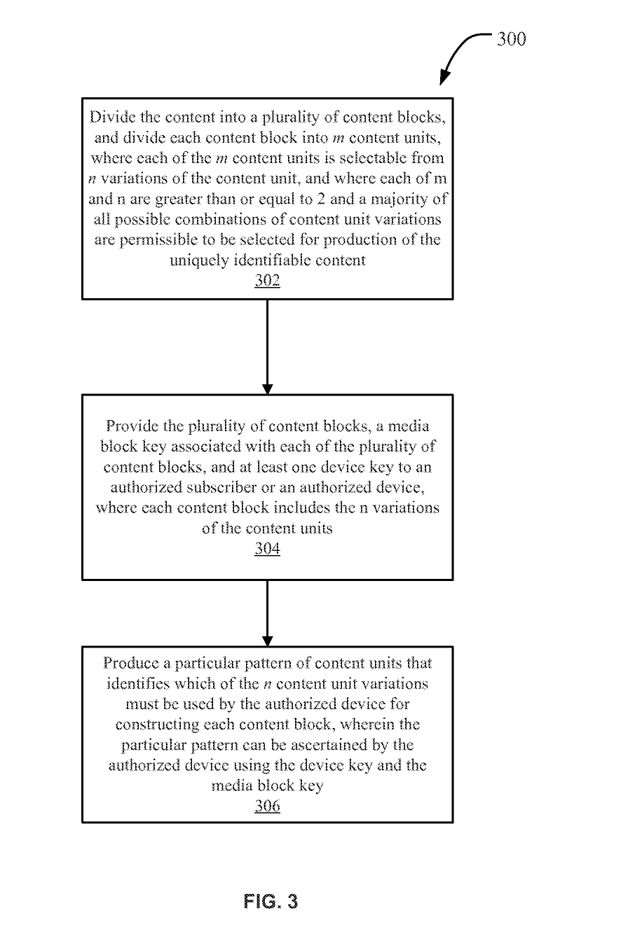

FIG. 3 illustrates a set of operations 300 that can be carried out to produce a uniquely identifiable content for real-time distribution. At 302, the content is divided into a plurality of content blocks, and divide each content block into m content units, where each of the m content units is selectable from n variations of the content unit. Each of m and n are greater than or equal to 2 and a majority of all possible combinations of content unit variations are permissible to be selected for production of the uniquely identifiable content. At 304, the plurality of content blocks, a media block key associated with each of the plurality of content blocks, and at least one device key to an authorized subscriber or an authorized device, where each content block includes the n variations of the content units. At 306, a particular pattern of content units is produced that identifies which of the n content unit variations must be used by the authorized device for constructing each content block. The particular pattern can be ascertained by the authorized device using the device key and the media block key. The values of m and n can be adjusted to provide the desired level of security and/or the computational complexity that allows quick identification of the culprit device or subscriber. For example, m and n can be selected such that the culprit device or culprit subscriber can be identified upon recovery of two content blocks. As noted earlier, the variation in content units can be produced in different techniques (or combinations of techniques). For example, each variation of the content unit can be produced by embedding one of n watermark values into each content unit. In another example, each variation of the content unit can be produced by encrypting each content unit using n distinct encryption keys. In yet another example, each variation of the content unit can be produced by using a uniform resource locator (URL) that includes a difficult-to-guess portion.

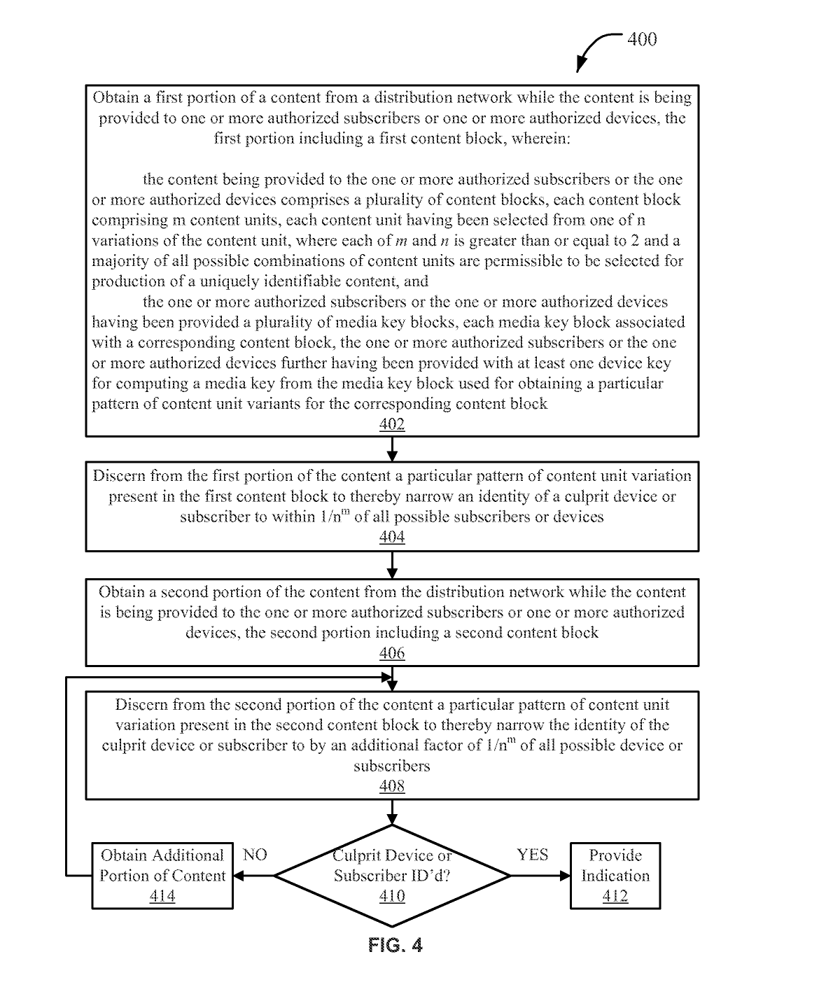

FIG. 4 illustrates a set of operations 400 that can be carried out to thwarting real-time piracy of a content. At 402, a first portion of a content is obtained from a distribution network while the content is being provided to one or more authorized subscribers or one or more authorized devices, the first portion including a first content block. For example, such a distribution network can be a public or private network that can be accessed on the Internet. The content that is being provided to the one or more authorized subscribers or the one or more authorized devices comprises a plurality of content blocks, where each content block includes m content units, and where each content unit having been selected from one of n variations of the content unit. Each of m and n is greater than or equal to 2 and a majority of all possible combinations of content units are permissible to be selected for production of a uniquely identifiable content. Further, the one or more authorized subscribers or the one or more authorized devices have been provided a plurality of media key blocks, where each media key block is associated with a corresponding content block, and the one or more authorized subscribers or the one or more authorized devices further have been provided with at least one device key for computing a media key from the media key block used for obtaining a particular pattern of content unit variants for the corresponding content block.

Referring back to FIG. 4, at 404, a particular pattern of content unit variation present in the first content block is discerned from the first portion of the content unit to thereby narrow an identity of a culprit device or subscriber to within 1/n^{m} of all possible subscribers or devices. At 406, a second portion of the content is obtained from the distribution network while the content is being provided to one or more authorized subscribers or one or more authorized devices, the second portion including a second content block. At 408, a particular pattern of content unit variation present in the second content block is discerned from the second portion of the content to thereby narrow the identity of the culprit device or subscriber by an additional factor of 1/n^{m} of all possible device or subscribers. At 410, a determination is made as to whether or not a single culprit device or subscriber has been identified. For example, the operation at 410 can be conducted using a record of authorized users and the associated keys that generate a corresponding content unit variation. If a single culprit device or subscriber has been identified, at 412 an indication is provided that the culprit device or subscriber has been identified. For example, such an indication can be used to revoke the transmission of content to the culprit device or subscriber and/or to revoke the credentials of the culprit device or subscriber so that despite receiving the real-time content, the culprit device or subscriber cannot obtain the media key or cannot view the real-time content.

Referring again to FIG. 4, upon a determination at 410 that a single culprit device or subscriber has not been identified, at 414, an additional portion of the content is obtained, and the operations at 406 through 410 are repeated until a single culprit device or subscriber is identified.

It should be noted that while the operations in FIGS. 3 and 4 are shown in a specific order, some of the operations can be combined together, can be carried out in a different order and/or broken up into multiple operations, all within the scope of the disclosed embodiments of the present application. For example, in one variation of FIG. 4, the operations at 410, 412 and 414 are conducted after the operations at 404 but before the operations at 406. In this variation, upon recovery of the first content block, it is determined if a single culprit device or subscriber has been identified. Only upon a failure to identify the culprit after examination of the first content block, additional content blocks are recovered and examined in an iterative fashion. In each iteration, the range of identities of the culprit device is further narrowed until the culprit device or subscriber is identified.

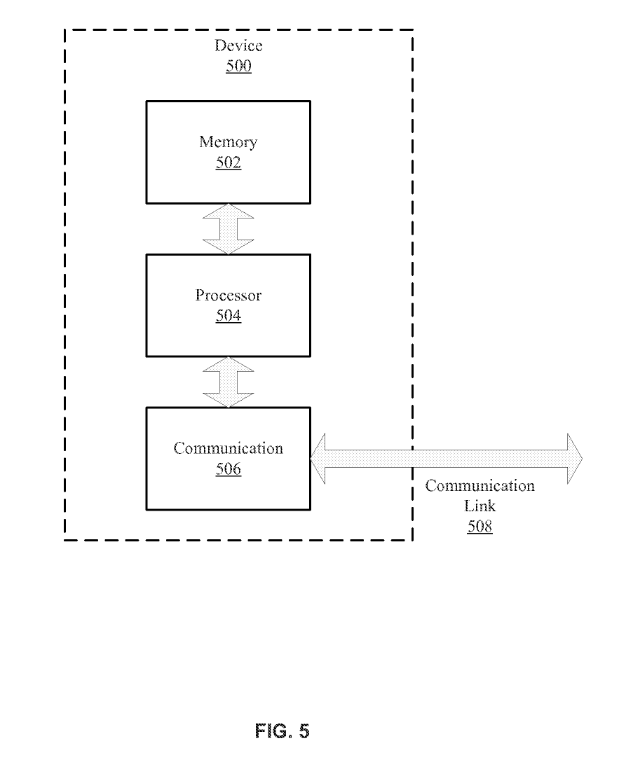

In some examples, the devices that are described in the present application can comprise a processor, a memory unit, and an interface that are communicatively connected to each other, and may range from desktop and/or laptop computers, to consumer electronic devices such as media players, mobile devices and the like. For example, FIG. 5 illustrates a block diagram of a device 500 within which various disclosed embodiments may be implemented. The device 500 comprises at least one processor 502 and/or controller, at least one memory 504 unit that is in communication with the processor 502, and at least one communication unit 506 that enables the exchange of data and information, directly or indirectly, through the communication link 508 with other entities, devices, databases and networks. The communication unit 506 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. The exemplary device 500 that is depicted in FIG. 5 may be integrated into as part of a device that can conduct the various operations that are described in the present application, such as the operations that are described in FIGS. 3 and 4.

It is understood that the various disclosed embodiments can be implemented individually, or collectively, in devices comprised of various hardware and/or software modules and components, or as a combination of hardware and software. In particular embodiments, a hardware implementation can include discrete analog and/or digital components that are, for example, integrated as part of a printed circuit board. Alternatively, or additionally, in particular embodiments, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

In describing the disclosed embodiments, sometimes separate components have been illustrated as being configured to carry out one or more operations. It is understood, however, that two or more of such components can be combined together and/or each component may comprise sub-components that are not depicted. Further, the operations that are described in various figures of the present application are presented in a particular sequential order in order to facilitate the understanding of the underlying concepts. It is understood, however, that such operations may be conducted in a different sequential order, and further, additional or fewer steps may be used to carry out the various disclosed operations.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1. A method for thwarting real-time piracy of a content, the method comprising:
(a) obtaining a first portion of a content from a distribution network while the content is being provided to one or more authorized subscribers or one or more authorized devices, the first portion including a first content block, wherein:
the content being provided to the one or more authorized subscribers or the one or more authorized devices comprises a plurality of content blocks, each content block comprising m content units, each content unit having been selected from one of n variations of the content unit, wherein each of m and n is greater than or equal to 2 and a majority of all possible combinations of content units are permissible to be selected for production of a uniquely identifiable content, and
the one or more authorized subscribers or the one or more authorized devices having been provided a plurality of media key blocks, each media key block associated with a corresponding content block, the one or more authorized subscribers or the one or more authorized devices further having been provided with at least one device key for computing a media key from the media key block used for obtaining a particular pattern of content unit variants for the corresponding content block;
(b) processing the first portion of the content using a processor that is implemented at least partially in hardware to identify a particular pattern of content unit variation present in the first content block to thereby narrow an identity of a culprit device or subscriber to within 1/nm of all possible subscribers or devices;
(c) obtaining a second portion of the content from the distribution network while the content is being provided to the one or more authorized subscribers or one or more authorized devices, the second portion including a second content block;
(d) processing the second portion of the content to identify a particular pattern of content unit variation present in the second content block to thereby narrow the identity of the culprit device or culprit subscriber by an additional factor of 1/nm of all possible device or subscribers;
(e) making a determination as to whether or not a single culprit device or subscriber has been identified, and
(f) upon a determination that a single culprit device or culprit subscriber has been identified, providing an indication that the single culprit device or culprit subscriber has been identified, and upon a determination that a single culprit device or culprit subscriber has not been identified, obtaining an additional portion of the content including an additional content block, and repeating operations (d), (e) and (f) using the additional portion of the content and the additional content block in place of the second portion of the content and the second content block, respectively.

2. The method of claim 1, wherein m and n are selected such that the culprit device or culprit subscriber is identified upon a single execution of operations (a) through (e).

3. The method of claim 1, wherein n is equal to 2.

4. The method of claim 1, wherein each variation of the content unit is produced by embedding one of n watermark values into each content unit.

5. The method of claim 1, wherein each variation of the content unit is produced by encrypting each content unit using n distinct encryption keys.

6. The method of claim 1, wherein each variation of the content unit is produced by allowing each content unit to be obtained using a uniform resource locator (URL) that includes a difficult-to-guess portion, wherein the difficult-to-guess portion of the URL includes: a value of a block unit key or hash value of a block unit key.

7-8. (canceled)

9. The method of claim 1, wherein all possible combinations of content units are permissible to be selected for production of the uniquely identifiable content.

10. The method of claim 1, wherein the at least one device key is delivered to the authorized device as a key with length d1 and upon reception at the authorized device, the length d1 is extended to a length d2 to compute the media key.

11. A device, comprising:
a processor; and
a memory including processor executable code, the processor executable code when executed by the processor causes the device to:
(a) obtain a first portion of a content from a distribution network while the content is being provided to one or more authorized subscribers or one or more authorized devices, the first portion including a first content block, wherein:
the content being provided to the one or more authorized subscribers or the one or more authorized devices comprises a plurality of content blocks, each content block comprising m content units, each content unit having been selected from one of n variations of the content unit, wherein each of m and n is greater than or equal to 2 and a majority of all possible combinations of content units are permissible to be selected for production of a uniquely identifiable content, and
the one or more authorized subscribers or the one or more authorized devices having been provided a plurality of media key blocks, each media key block associated with a corresponding content block, the one or more authorized subscribers or the one or more authorized devices further having been provided with at least one device key for computing a media key from the media key block used for obtaining a particular pattern of content unit variants for the corresponding content block;
(b) process the first portion of the content to identify a particular pattern of content unit variation present in the first content block to thereby narrow an identity of a culprit device or subscriber to within 1/nm of all possible subscribers or devices;
(c) obtain a second portion of the content from the distribution network while the content is being provided to the one or more authorized subscribers or one or more authorized devices, the second portion including a second content block;
(d) process the second portion of the content to identify a particular pattern of content unit variation present in the second content block to thereby narrow the identity of the culprit device or subscriber by an additional factor of 1/nm of all possible device or subscribers;
(e) make a determination as to whether or not a single culprit device or subscriber has been identified, and
(f) upon a determination that a single culprit device or culprit subscriber has been identified, provide an indication that the single culprit device or culprit subscriber has been identified, and upon a determination that a single culprit device or culprit subscriber has not been identified, obtain an additional portion of the content including an additional content block, and repeat operations (d), (e) and (f) using the additional portion of the content and the additional content block in place of the second portion of the content and the second content block, respectively.

12. The device of claim 11, wherein m and n are selected such that the culprit device or culprit subscriber is identified upon a single execution of operations (a) through (e).

13. The device of claim 11, wherein n is equal to 2.

14. The device of claim 11, wherein each variation of the content unit is produced by embedding one of n watermark values into each content unit.

15. The device of claim 11, wherein each variation of the content unit is produced by encrypting each content unit using n distinct encryption keys.

16. The device of claim 11, wherein each variation of the content unit is produced by allowing each content unit to be obtained using a uniform resource locator (URL) that includes a difficult-to-guess portion, wherein the difficult-to-guess portion of the URL includes a value of a block unit key or hash value of a block unit key.

17-19. (canceled)

20. A computer program product embodiment on one or more non-transitory computer readable media, the computer program product comprising:
computer code for (a) obtaining a first portion of a content from a distribution network while the content is being provided to the one or more authorized subscribers or one or more authorized devices, the first portion including a first content block, wherein:
the content being provided to the one or more authorized subscribers or the one or more authorized devices comprises a plurality of content blocks, each content block comprising m content units, each content unit having been selected from one of n variations of the content unit, wherein each of m and n is greater than or equal to 2 and a majority of all possible combinations of content units are permissible to be selected for production of a uniquely identifiable content, and
the one or more authorized subscribers or the one or more authorized devices having been provided a plurality of media key blocks, each media key block associated with a corresponding content block, the one or more authorized subscribers or the one or more authorized devices further having been provided with at least one device key for computing a media key from the media key block used for obtaining a particular pattern of content unit variants for the corresponding content block;
computer code for (b) processing the first portion of the content to identify a particular pattern of content unit variation present in the first content block to thereby narrow an identity of a culprit device or subscriber to within 1/nm of all possible subscribers or devices;
computer code for (c) obtaining a second portion of the content from the distribution network while the content is being provided to the one or more authorized subscribers or one or more authorized devices, the second portion including a second content block;
computer code for (d) processing the second portion of the content to identify a particular pattern of content unit variation present in the second content block to thereby narrow the identity of the culprit device or subscriber by an additional factor of 1/nm of all possible device or subscribers;
computer code for (e) making a determination as to whether or not a single culprit device or subscriber has been identified, and
computer code for (f) upon a determination that a single culprit device or culprit subscriber has been identified, providing an indication that the single culprit device or culprit subscriber has been identified, and upon a determination that a single culprit device or culprit subscriber has not been identified, obtaining an additional portion of the content including an additional content block, and repeating operations (d), (e) and (f) using the additional portion of the content and the additional content block in place of the second portion of the content and the second content block, respectively.

21. A method for producing a uniquely identifiable content for real-time distribution, the method comprising:
processing the content using a processor that is implemented at least partially in hardware to divide the content into a plurality of content blocks, and to divide each content block into m content units, wherein each of the m content units is selectable from n variations of the content unit, wherein each of m and n is greater than or equal to 2 and a majority of all possible combinations of content unit variations are permissible to be selected for production of the uniquely identifiable content;
providing the plurality of content blocks, a media block key associated with each of the plurality of content blocks, and at least one device key to an authorized subscriber or an authorized device, wherein each content block includes the n variations of the content units; and
producing, by the processor, a particular pattern of content units that identifies which of the n content unit variations must be used by the authorized device for constructing each content block, wherein the particular pattern can be ascertained by the authorized device using the device key and the media block key.

22. The method of claim 21, wherein m and n are selected such that the culprit device or culprit subscriber is identifiable from two content blocks.

23. The method of claim 21, wherein n is equal to 2.

24. The method of claim 21, comprising producing each variation of the content unit by embedding one of n watermark values into each content unit.

25. The method of claim 21, comprising producing each variation of the content unit by encrypting each content unit using n distinct encryption keys.

26. The method of claim 21, comprising producing each variation of the content unit using a uniform resource locator (URL) that includes a difficult-to-guess portion, wherein the difficult-to-guess portion of the URL includes a value of a block unit key or hash value of a block unit key.

27-30. (canceled)

31. The method of claim 21, wherein the plurality of content blocks are delivered to the authorized device as a real-time content, and the at least one device key is delivered to the authorized device or the authorized user prior to real-time delivery of the content blocks.

32. A device, comprising:
a processor; and
a memory including processor executable code, the processor executable code, when executed by the processor, causes the device to:
process the content to divide the content into a plurality of content blocks, and divide each content block into m content units, wherein each of the m content units is selectable from n variations of the content unit, wherein each of m and n is greater than or equal to 2 and a majority of all possible combinations of content unit variations are permissible to be selected for production of the uniquely identifiable content;
provide the plurality of content blocks, a media block key associated with each of the plurality of content blocks, and at least one device key for transmission to an authorized subscriber or an authorized device, wherein each content block includes the n variations of the content units; and
produce a particular pattern of content units that identifies which of the n content unit variations must be used by the authorized device for constructing each content block, wherein the particular pattern can be ascertained by the authorized device using the device key and the media block key.

33. The device of claim 32, wherein m and n are selected such that the culprit device or culprit subscriber is identifiable from two content blocks.

34. The device of claim 32, wherein n is equal to 2.

35. The device of claim 32, wherein the processor executable code, when executed by the processor, causes the device to produce each variation of the content unit by embedding one of n watermark values into each content unit.

36. The device of claim 32, wherein the processor executable code, when executed by the processor, causes the device to produce each variation of the content unit by encrypting each content unit using n distinct encryption keys.

37. The device of claim 32, wherein the processor executable code, when executed by the processor, causes the device to produce each variation of the content unit using a uniform resource locator (URL) that includes a difficult-to-guess portion, wherein the difficult-to-guess portion of the URL includes a value of a block unit key or hash value of a block unit key.

38-40. (canceled)

41. The device of claim 32, wherein the processor executable code, when executed by the processor, causes the device to deliver the at least one device key to the authorized device as a key with length d1 that is shorter than a length d2 needed to compute the media key.

42. The device of claim 32, wherein the processor executable code, when executed by the processor, causes the device to deliver the plurality of content blocks to the authorized device as a real-time content, and the at least one device key to the authorized device or the authorized user prior to real-time delivery of the content blocks.

43. A computer program product embodiment on one or more non-transitory computer readable media, the computer program product comprising:
computer code for processing the content to divide the content into a plurality of content blocks, and dividing each content block into m content units, wherein each of the m content units is selectable from n variations of the content unit, wherein each of m and n is greater than or equal to 2 and a majority of all possible combinations of content unit variations are permissible to be selected for production of the uniquely identifiable content;
computer code for providing the plurality of content blocks, a media block key associated with each of the plurality of content blocks, and at least one device key to an authorized subscriber or an authorized device, wherein each content block includes the n variations of the content units; and
computer code for producing a particular pattern of content units that identifies which of the n content unit variations must be used by the authorized device for constructing each content block, wherein the particular pattern can be ascertained by the authorized device using the device key and the media block key.
